(19) United States
(12) Patent Application Publication
(10) Pub. No.: US 2010/0011930 A1
(43) Pub. Date: Jan. 21, 2010

(54) Kid safe material cutting apparatus

(76) Inventor: DANE SCARBOROUGH, Hailey, ID (US)

Correspondence Address: DYKAS, SHAVER & NIPPER, LLP, P.O. BOX 877, BOISE, ID, 83701-0877, US

(21) Appl. No.: 12/420,369

(22) Filed: Apr. 8, 2009

Related U.S. Application Data
(60) Provisional application No. 61/081,643, filed on Jul. 17, 2008.

(51) Int. Cl. B26D 1/08; B26D 7/22; B26D 7/27; B26D 5/10

(52) U.S. Cl. 83/522.17; 83/697; 83/545; 83/563; 83/631

(57) ABSTRACT

A handheld device for cutting material, preferably linear material, such as ice pop sticks, building sticks, chalk sticks, dowels, plastic toy construction pieces, candy, and paper. The device having a cutting portion having a blade, a control portion controlling the cutting portion, and a base portion. The device configured, for instance by having a small hole into which the portion of the material to be cut is inserted, so as to prevent the user, such as a child, from being injured by contact with the blade.

### PRIORITY

This application is a non-provisional of provisional application 61/081,643, filed on Jul. 17, 2008 by Dane Scarborough with the title “Kid Safe Material Cutting Apparatus,” the disclosure of which is incorporated herein by reference.

### BACKGROUND

Many times, individuals (e.g., children, crafters, makers, hobbyists, scrap-bookers) have a need to cut lengths of material (e.g., Popsicle® sticks, building sticks, chalk sticks, dowels, plastic toy construction pieces, candy, cardboard, ribbon, paper). Traditional options for cutting such material include the use of razor blades, razor knives, knives, and scissors. The disadvantages to these traditional options are obvious, namely users are frequently harmed while using them and they oftentimes require a tremendous exertion of force to accomplish the cutting.

### SUMMARY OF THE INVENTION

Shown is a handheld, portable cutting device (cutter) for cutting material, preferably linear material. The cutting device having a cutting portion having a cutting blade, a control portion (cutting force applying means) controls the cutting portion, and a base portion (body).

### BRIEF DESCRIPTION OF THE DRAWINGS

FIG. 1 is a perspective view of a first embodiment of a portable cutting device.

FIG. 2 is a perspective view of a subassembly of certain components of the embodiment of FIG. 1.

FIG. 3 is a front view of a subassembly of certain components of the embodiment of FIG. 1.

FIG. 4 is a side view of a subassembly of certain components of the embodiment of FIG. 1.

FIG. 5 is a front view of the embodiment of FIG. 1, shown with the material brake engaged.

FIG. 6 is a front view of the embodiment of FIG. 1, shown with the material brake disengaged.

FIG. 7 is a front view of the embodiment of FIG. 1, shown with the material brake engaged and with the blade raised.

FIG. 8 is a rear view of the embodiment of FIG. 1, shown with the blade lowered.

FIG. 9 is a side view of the embodiment of FIG. 1, shown with the blade raised.

FIG. 10 is a side view of the embodiment of FIG. 1, shown with the blade lowered.

FIG. 11 is a top view of the embodiment of FIG. 1.

FIG. 12 is a bottom view of the embodiment of FIG. 1.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined herein.

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

Show is a handheld device for cutting material, preferably linear material, referred to herein as the portable cutting device 10. The preferred material (herein referred to collectively as a “craft stick”) to be cut includes, but is not limited to, Popsicle® sticks, building sticks, craft sticks, chalk sticks, wooden dowels, tubes, rods, plastic toy construction pieces, candy, and paper.

The portable cutting device is configured to cut a craft stick into more than one piece, through making bisecting cuts, cuts at an angle, and/or “rip” cuts. These craft sticks having a top surface opposite a bottom surface, and a pair of opposing long sides. Other shapes and configurations of “craft sticks” are likewise envisioned; the description of one preferred craft stick made here in example to aid a reader in understanding the basic premise behind the described embodiments.

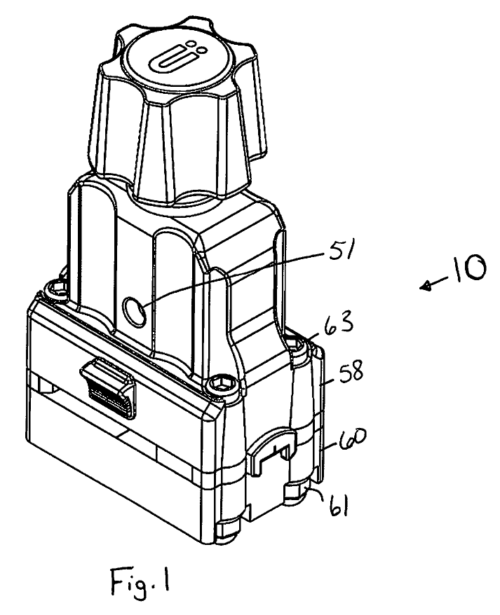

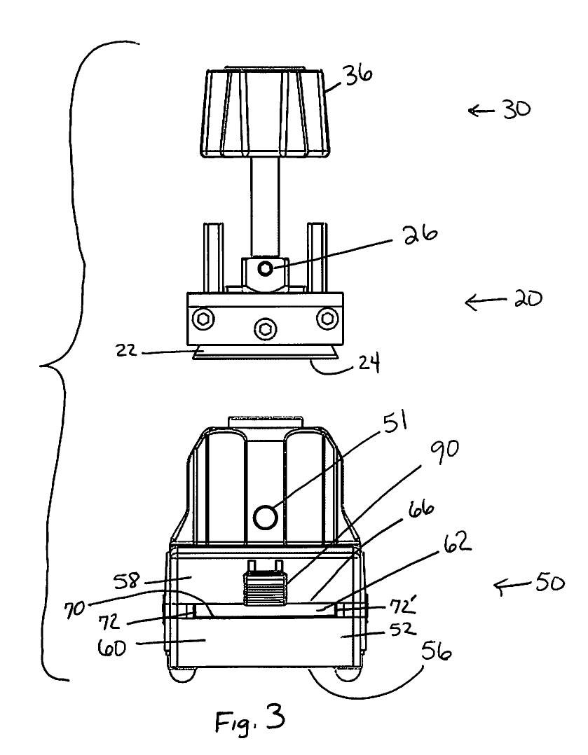

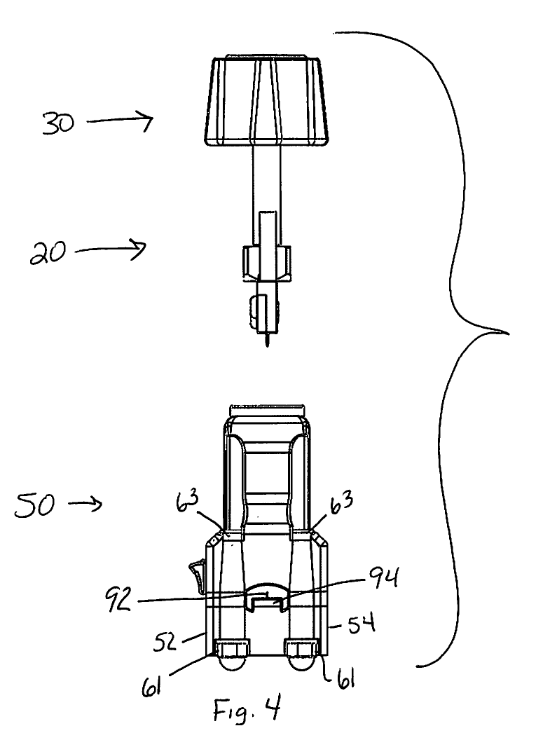

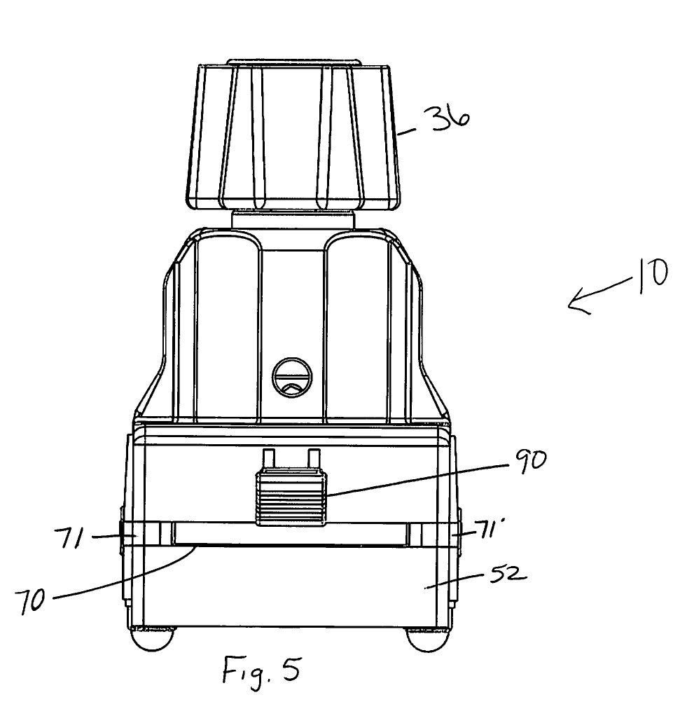

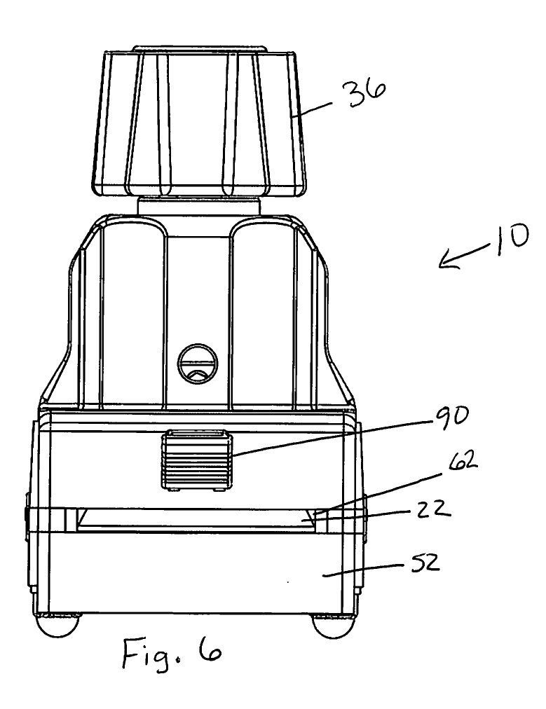

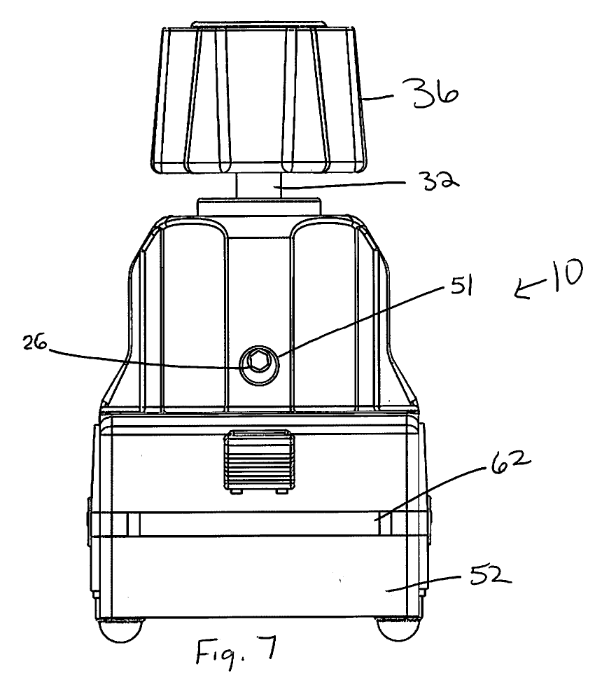

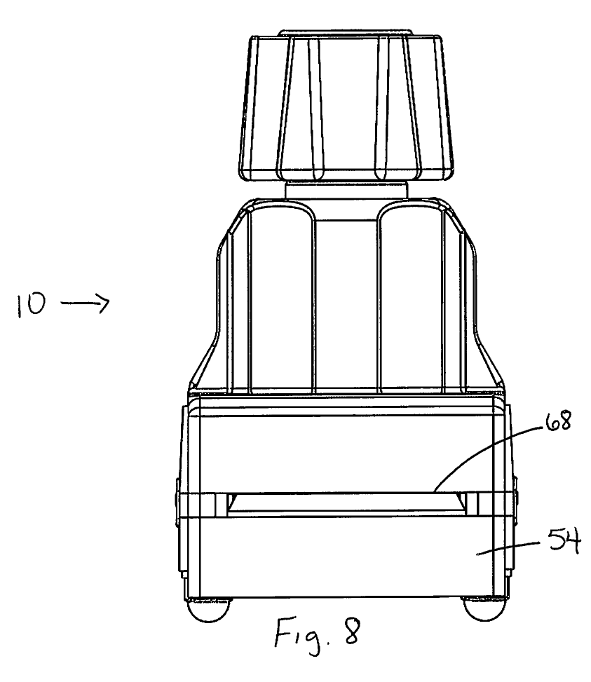

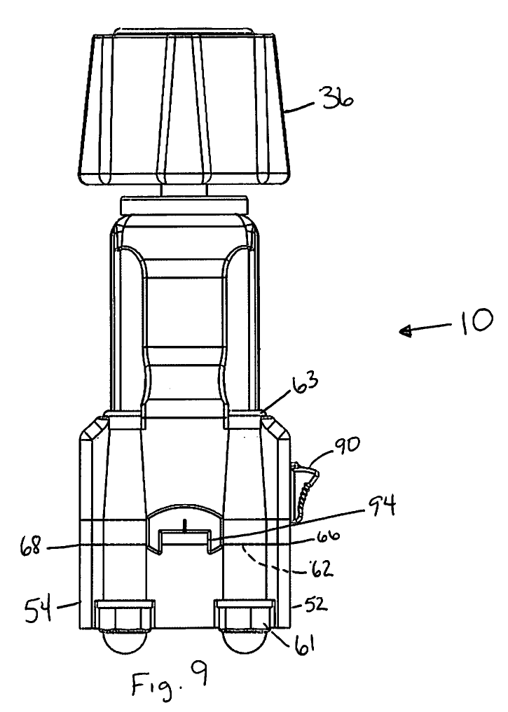

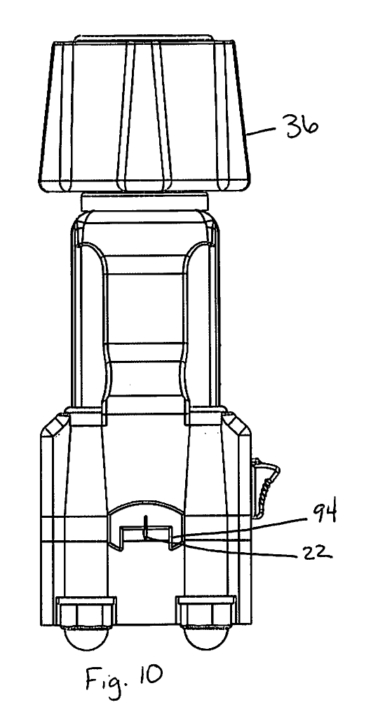

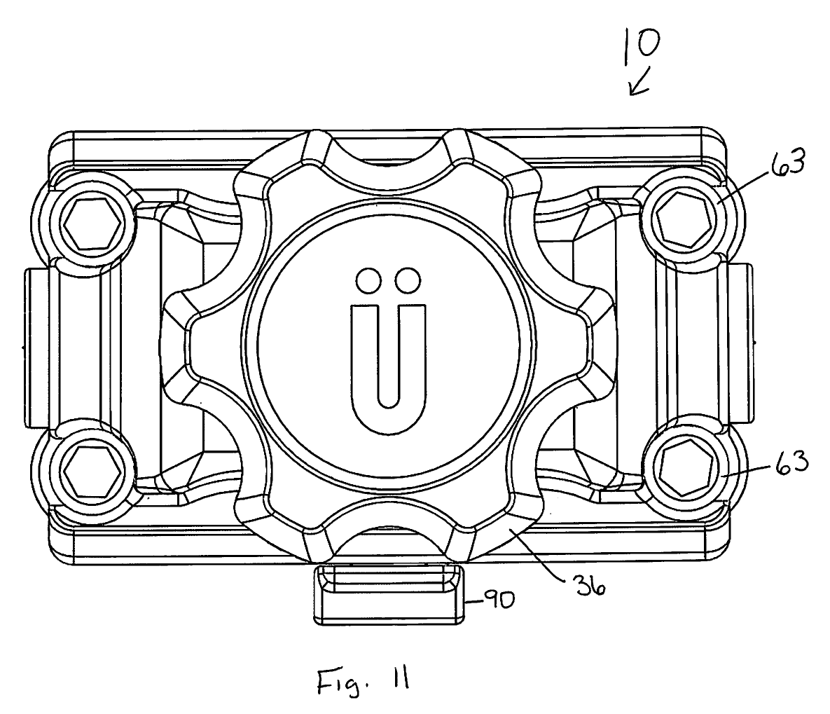

FIGS. 1-12 show one embodiment of a portable cutting device 10.

The portable cutting device 10 having a cutting portion 20 for cutting the material, a control portion 30 controlling the cutting portion, and a base portion 50 supporting the cutting and control portions.

The cutting portion 20 having at least one blade 22 having a cutting edge 24. The cutting edge preferably being straight, defining a cutting axis. The preferred blade is a razor, however other blades may be utilized. The preferred blade is straight, but shaped blades could be utilized as well. Multiple blades could be utilized in some embodiments. The blade could be shaped to perform a die cut, for instance for cutting holes in the material instead of cutting the material into one or more pieces.

The control portion (force applying means) 30 is utilized to control the cutting portion's cutting action. In the embodiment shown, the cutting device 10 having a cutting force applying means 30 operatively connected with the mounting means 31 to impart a cutting force thereto to cut the craft stick.

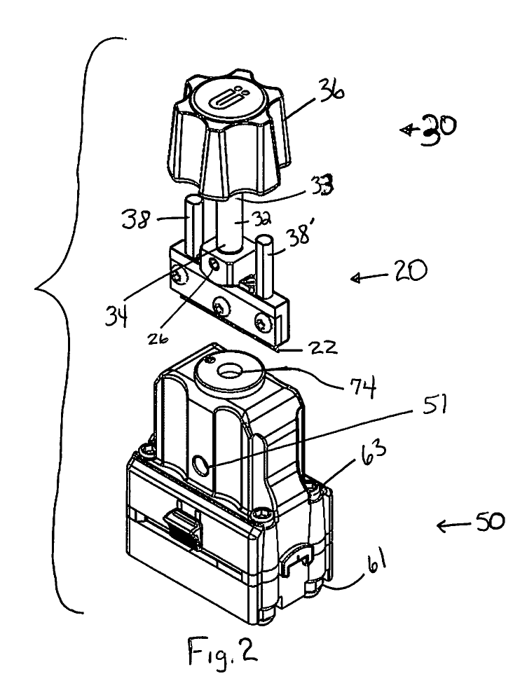

FIGS. 2-4 show the cutting portion/control portion (20, 30) separate from the base portion 50. This view is not natural, and is done to help explain the figures and embodiment to the readers hereof. Thus, starting at the configuration shown in FIG. 1, (1) an Allen wrench would be inserted through the access port 51 to unscrew the fastener 26, thereby releasing the cutting portion 20 from its connection to the control portion 30, (2) the recessed fasteners (61, 63) would be disconnected from one another thereby enabling the top half 58 to be separated from the bottom half 60, (3) this would allow the cutting portion 20 to be removed from inside of the base portion 50, (4) the cutting portion 20 would then be reattached to the control portion 30, and (5) the top/bottom halves reattached via the fasteners thereby resulting in the view shown in FIGS. 2-4.

In one configuration, the cutting force applying means 30 may comprise a linear actuator operating to move the mounting means 31 and the mounted cutting blade 22 from a retracted position, to an initiation position where said cutting blade 22 barely engages said craft stick upper surface, to a cutting position where said cutting blade 22 operates to cut said craft stick.

The control portion comprises a threaded rod 32 having a first end 33 extending to a second end 34. The blade 22 preferably attaches to the rod second end 34. A control knob 36 is provided adjacent the rod first end 33 for allowing a user to manually operate the control portion and cause the cutting device to cut the material to be cut. For instance, turning the control knob in a clockwise direction could result in the threaded rod advancing through threading in the base portion thereby causing the blade to move into its cutting position, while turning the control knob in a counter-clockwise direction could result in the blade moving away from its cutting position.

Such a screw mechanism is preferred for a number of reasons, including the fact that it would be easy for a child to operate and apply a tremendous amount of force (required to cut some materials) with little effort. Other mechanisms, including but not limited to levers and cams, could likewise be used.

A pair of linear motion guides 38, 38′ are shown. The linear motion guides are utilized to fix the cutting edge axis within a cutting plane as the control portion moves the cutting portion into its cutting position. In the embodiment shown in the drawings, the cutting portion has a first position where it is disengaged and a second position where it is engaged. While linear motion guides are the preferred manner of keeping the cutting edge aligned, other manners of accomplishing the same thing are likewise envisioned.

The rod 32 could be threaded and configured for receipt into a threaded passageway within the base portion 50. This threaded passageway discussed later in this disclosure.

The base portion of the preferred embodiment having a front side 52, a back side 54, and a bottom side 56. It is preferred that the base portion 50 comprise a top half 58, secured to a bottom half 60 through use of one or more recessed fasteners 61 (e.g., hex screws, bolts, nuts). The purpose of using such recessed fasteners is to make it more difficult for a child to separate the two halves and access the blade. Such a “two half” configuration would allow the base portion to be disassembled for a variety of reasons, including allowing access by an adult of the blade portion 22 for replacement when the blade becomes dull.

The side of the base portion 50 could further comprise a side passage 94 there-through for allowing the craft stick to be ripped by the blade instead of the angular/orthogonal cuts discussed above. Such a cut could allow a standard craft stick to be cut into scale 2×4 dimensional lumber, for instance. Preferably, a center mark 92 is provided for allowing a user to better gauge the location of the cutting plane of the blade.

It is preferred that a brake be provided for holding the material to be cut (namely, the craft stick) in place while the cut is made. The figures show one particular implementation of a material brake 90, this embodiment showing a switch on the front side 52 of the body that can be moved from a disengaged position (particularly shown in FIGS. 1, 6 and 7) to an engaged position (particularly shown in FIGS. 2, 3 and 5) whereby the craft stick is clamped and/or otherwise held in place while the cutting process takes place. In one embodiment the brake's body visible on the outside of the cutter is spring biased downwards (towards the support surface 70. A user would manipulate the brake's body upwards, thereby releasing the braking mechanism. Upon insertion of a craft stick into the passageway, the pressure on the brake's body could be released, allowing the spring to engage the brake assembly, thereby holding the craft stick's alignment within the passageway while the user operates the control portion to cut the craft stick through use of the cutting portion. The brake also serving to hold the cut pieces after cutting, thereby preventing a shard of cut material from being shot out of the passageway (e.g., where the material cut is brittle).

It is preferred that at least a portion of the base portion be generally transparent so as to allow a user to be able to see the orientation of the material to be cut, thereby enabling the user to cut the material at a desired angle with a decreased chance of error. Alternatively, windows or other openings could be provided within the base portion for accomplishing the same goal.

It is preferably a cutting passageway 62 extends through the base portion 50. The cutting passageway defining a cutting passageway axis. The passageway shown in the Figures is a rectangular slot through the base portion. Other shapes are possible. The cutting passageway shown in the Figures beginning at an open first end 66 within the front side 52 and extending through the base portion 50 to a cutting passageway open second end 68 in the back side 54.

Preferably, the cutting passageway axis is perpendicular to the cutting edge axis. While this is preferred, alternatively, the passageway and/or the orientation of the blade could be rotated relative to one another so as to allow angles and/or compound angles to be cut. Additionally, the passageway could be sized for receipt of an insert, this insert allowing the angle of the material to be cut to be changed, thereby providing for cutting of the material at an angle, whether that angle is lateral or longitudinal to the axis of the elongated material to be cut.

The passageway preferably having a bottom surface 70 for supporting the material to be cut. In use, the material to be cut is effectively sandwiched between the blade and the bottom surface. In such a configuration, the bottom surface provides the cutting surface against which the blade can press the material to be cut as the material is cut.

It is preferred that the passageway have at least one side wall 72 for allowing material to be held against it by the user and held at a pre-determined angle to the blade axis. For instance, where the passageway itself is generally perpendicular to the cutting edge axis, the side walls would generally be at a 90° angle to the blade axis, and by holding a linear material having parallel sides against the side wall, cutting the material to be cut would result in a generally right angle being cut into the material. It is also possible that one or more of the side walls could be configured with an angle other than 90° (e.g., 30°, 45°) for enabling the materials to be cut into non-right angle shapes.

The passageway 62 for positioning a craft stick to be cut, including a support surface 70 upon which a craft stick to be cut is placed with its bottom surface facing the support surface 70.

Additionally, the passageway could be sized for receipt of an insert, this insert allowing the angle of the material to be cut to be changed, thereby providing for cutting of the material at an angle, whether that angle is lateral or longitudinal to the axis of the elongated material to be cut. In use, the material to be cut is effectively sandwiched between the blade and the bottom surface. In such a configuration, the bottom surface provides the cutting surface against which the blade can press the material to be cut as the material is cut.

The base portion 50 further having defined therein a passageway 74 for the rod. It is preferred that this passageway 74 be threaded with threads (not shown) for receiving a rod 32 having threads. In such a configuration, the second end of the rod could be manipulated relative to the top portion of the base portion through screwing the rod into the base portion or by unscrewing the rod from the base portion. Doing so resulting in the rod's second end is configured for moving vertically either upward or downward along the axis of the rod itself.

It is preferred that the base portion 50 also comprise at least one passageway (not shown) for receiving the cutting portion's linear motion guides 38, 38′ when so configured.

It is also preferred that the blade portion, when not in its cutting position, be configured for receipt into a recess (not shown) defined within the base portion.

It is preferred that the mounting means comprise a pair of linear motion guides 38, 38′ which are guided in respective channels (not shown) formed in the body 50. The linear motion guides are utilized to fix the cutting edge axis within a cutting plane as the cutting force applying means moves the cutting blade into its cutting position. While linear motion guides are the preferred manner of keeping the cutting edge aligned, other manners of accomplishing the same thing are likewise envisioned.

In one embodiment, the linear actuator comprising a nut having internal threads configured for mating with the external threads of a screw. The nut configured for locking into the top half of the body so as to prevent rotation of the nut. The screw having a first end configured for engaging the knob, and a free spinning second end terminating in a swivel connection with the mounting means. Such a swivel connection allowing rotation of the screw to cause rotation of the screw's threads, but not rotation of the mounting means. When this embodiment of the cutter is assembled, rotation of the knob results in rotation of the screw relative to the nut, thereby causing the attached mounting means and blade to be raised or lowered relative to the support surface.

The control knob may utilize a handle rod (not shown) to assist in its rotation. Rotation of the knob in a first direction thereby causing the blade edge to move towards the support surface, whereas rotation of the knob in a second direction thereby causing the blade edge to move away from the support surface.

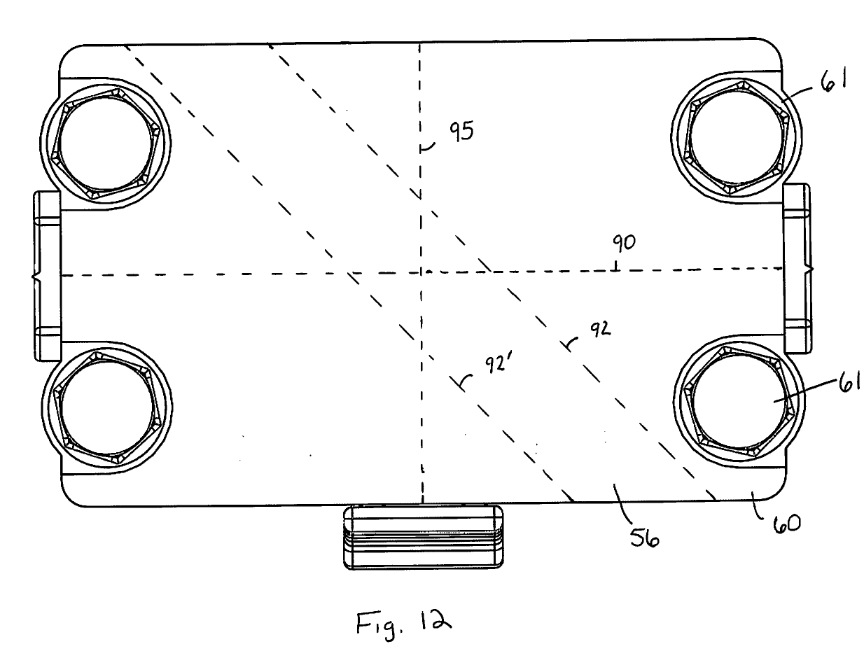

In the embodiment shown particularly in FIG. 12, the body 60 comprises a plurality of alignment marks (90, 92, 92′, 95) for allowing a user to align a craft stick to be cut along a desired angle. Alignment mark 90 shows a line generally perpendicular to the passageway (as defined by the sidewalls), thereby itself defining a cutting passageway axis, and alignment mark 95 shows a line generally centered and parallel to the passageway. Alignment marks 92 and 92′ showing a forty-five degree angle relative to the cutting passageway axis 90, these two alignment marks being spaced apart the width of a common ice pop stick. Other alignment marks could be present, defining other common angles (e.g., sixty degrees, thirty degrees, twenty-two and one-half degrees, fifteen degrees). Such alignment marks particularly useful where the cutting blade has a cutting edge that is locked into a particular cutting plane. Alternatively, the cutting blade could not be locked into a fixed cutting plane and could, instead, be adjustable. The alignment marks could be located any number of places, including but not limited to adjacent the support surface, within the base itself, or on the underside of the base.

It is preferred that the passageway have at least one generally straight sidewall (72, 72′) extending between the first and second openings for allowing material to be held against it by the user and held at a pre-determined angle to the blade axis. It is preferred that the craft stick has a pair of parallel long sides, and at least one of said sidewalls is generally perpendicular to the cutting plane, thereby allowing one of the craft stick long sides to be held against the sidewall generally perpendicular to the cutting plane and the craft stick cut perpendicular to the craft stick long side. It is also possible that one or more of the side walls could be configured with an angle other than 90° (e.g., 30°, 45°) for enabling the materials to be cut into non-right angle shapes.

In the embodiment shown, a pair of spacers (71, 71′) are used to space provide the sidewall(s) (if present). These spacers are also used to control the height of the passageway, allowing the passageway height to be configured relative to the use (or user), for instance short spacers could be used to size the passageway height to as to be small enough a child could not insert his/her finger therein. The passageways are preferably the same height, although differences in height and shape could be used to allow the device to cut on a bias or result in the blade being not generally perpendicular to the support surface. Alternatively, one or more of the spacers could be shaped with predetermined angles therein, for allowing a user to make a predetermined angle cut to the craft stick. Optionally, the device could be configured to be disassembled by the user so that the spacers could be switched out with other spaces (e.g., having differing angles) or could be rotated from a straight side to an angled side.

It is preferred that the cutting edge 24 be generally parallel to the support surface 70, however it is also possible that the cutting edge not be generally parallel to said support surface, for instance beginning cutting on one of the long sides before the other begins. Alternatively, the pitch of the blade could be changed, allowing cuts to be made along a bias.

In another potential embodiment of a cutting force applying means, the cutting force applying means comprises a linear actuator operating to move the mounting means and the mounted cutting blade from a retracted position, to an initiation position, to a cutting position. In such an embodiment, the linear actuator could comprise a leadscrew, namely an internally treaded sleeve configured for receiving an externally threaded shaft. The rotation of the shaft causing the shaft to unscrew out of (or in to) the sleeve. The shaft preferably configured for rotation by a control knob (not shown). As such, the control knob would control the operation of the linear actuator.

In another potential embodiment, an epicyclic gearing system is used. For instance, wherein said shaft terminates in a central (sun) gear surrounded by one or more outer (planetary) gears meshed together by an outer ring gear (annulus). A stationary carrier (not shown) interconnects the outer gears. The outer ring gear configured for connecting with, for instance insertion into, a control knob (not shown), so that rotation of the control knob results in rotation of the shaft and movement of the cutting blade relative to the support surface. Rotation of the knob in a first direction thereby causing the knife edge to move towards the support surface, whereas rotation of the knob in a second direction thereby causing the knife edge to move away from the support surface. The benefit of using such an epicyclic gearing system is that small input rotation of the control knob can be converted into a much more dramatic output rotation (of the shaft), thereby allowing a user, particularly a child, to operate the cutting device with minimal effort.

It is preferred that the body 50 has a base 60. It is preferred that the base 60 comprise a generally transparent base enabling a user of the cutting device to see through said base 60 (such as is shown in FIG. 12). Alternatively, just a portion of said base could be transparent. This transparency so as to allow a user to be able to see the orientation of the material to be cut, thereby enabling the user to cut the material at a desired angle with a decreased chance of error. Alternatively, windows or other openings could be provided within the body for accomplishing the same goal.

The portable cutting device, is preferably “hand-held” and used. However, that is not intended to be a limitation, in that it is expressly envisioned that other configurations are possible, including but not limited to the cutting device being mounted on a wall like a school pencil sharpener and/or the cutting device being mounted upon a surface such as a desk or table.

While there is shown and described the present preferred embodiment(s) of the invention, it is to be distinctly understood that this invention is not limited thereto but may be variously embodied to practice within the scope of this disclosure. From the foregoing description, it will be apparent that various changes may be made without departing from the spirit and scope of the invention as defined by this disclosure.

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, nor is it intended to be limiting as to the scope of the invention in any way.

Still other features and advantages of the invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

I claim:

1. An improved cutter for cutting a craft stick, said craft stick having a top surface opposite a bottom surface, said cutter comprising:
a body, said body defining a first opening on a first side and a second opening on a second side, said first and second openings defining a passageway through said body, said passageway for positioning a craft stick to be cut, said passageway having a support surface upon which a craft stick to be cut is placed with its bottom surface facing said support surface;
a mounting means extending above the support surface and mounting a cutting blade for movement toward and away from the support surface in a cutting plane;
a cutting blade mounted on said mounting means for said movement in said cutting plane, said cutting blade having a cutting edge engagable with the top surface of the craft stick when placed on the support surface; and
a cutting force applying means operatively connected with the mounting means to impart a cutting force thereto to cut said craft stick, wherein the cutting force applying means comprises a linear actuator operating to move the mounting means and the mounted cutting blade from a retracted position, to an initiation position where said cutting blade barely engages said craft stick upper surface, to a cutting position where said cutting blade operates to cut said craft stick.

2. The cutter of claim 1, wherein said body comprises a base, and wherein at least a portion of said base is generally transparent.

3. The cutter of claim 1, wherein said body comprises a plurality of alignment marks for allowing a user to align a craft stick to be cut along a desired angle.

4. The cutter of claim 3, wherein said alignment marks define a plurality of angles.

5. The cutter of claim 2, wherein said body comprises a plurality of alignment marks for allowing a user to align a craft stick to be cut along a desired angle, wherein said alignment marks define a plurality of angles, and wherein said alignment marks are located adjacent said generally transparent base.

6. The cutter of claim 3, wherein said alignment marks are located adjacent said support surface.

7. The cutter of claim 1, wherein said body passageway has at least one generally straight sidewall extending between said first and second openings.

8. The cutter of claim 7, wherein the orientation of said cutting plane relative to said sidewall is adjustable from 0 degrees to 180 degrees.

9. The cutter of claim 7, wherein said cutting plane is generally perpendicular to said sidewall.

10. The cutter of claim 1, wherein said cutting edge is generally parallel to said support surface.

11. The cutter of claim 1, wherein said cutting force applying means comprises a control knob configured for turning, the control knob controlling the linear actuator's operation.

12. The cutter of claim 11, wherein said control knob includes an epicyclic gearing system for assisting in the control of the linear actuator's operation.

13. The cutter of claim 1, wherein said linear actuator comprises a nut having internal threads and a screw having external threads, wherein said nut is configured to be fixed in said body, and wherein said internal threads are configured for mating with said external threads.

14. The cutter of claim 1, wherein said body comprises a plurality of alignment marks for allowing a user to align a craft stick to be cut along a desired angle, said alignment marks defining a plurality of angles, wherein a craft stick to be cut can be placed upon the support surface, the cutting force applying means operated to move the mounted cutter blade from its retracted position to the initiation position where said cutting blade barely engages said craft stick upper surface, wherein said user then adjusting the orientation of the craft stick to align the craft stick with at least one of said alignment marks, whereupon said mounted cutter blade is moved into its cutting position where said cutting blade operates to cut said craft stick.

15. The cutter of claim 1, wherein said craft stick has a pair of parallel long sides, and wherein at least one of said sidewalls is generally perpendicular to said cutting plane thereby allowing one of said craft stick long sides to be held against said sidewall and the craft stick cut perpendicular to said craft stick long side.

16. The cutter of claim 1, wherein said mounting means comprises a pair of linear motion guides which are guided in respective channels formed in said body.

17. An improved cutter for a craft stick, said craft stick having a top surface opposite a bottom surface, said cutter comprising:
a body, said body defining a first opening on a first side and a second opening on a second side, said first and second openings defining a passageway through said body, said passageway for positioning a craft stick to be cut, said passageway having a support surface upon which a craft stick to be cut is placed with its bottom surface facing said support surface, said body having a generally transparent base and a plurality of alignment marks for allowing a user to align a craft stick to be cut along a desired angle, said alignment marks defining a plurality of angles;
a mounting means extending above the support surface and mounting a cutting blade for movement toward and away from the support surface in a cutting plane;
a cutting blade mounted on the mounting means for said movement in the cutting plane, the cutting blade having a cutting edge engagable with the top surface of the craft stick when placed on the support surface; and
a cutting force applying means operatively connected with the mounting means to impart a cutting force thereto to cut said craft stick, wherein the cutting force applying means comprises a linear actuator operating to move the mounting means and the mounted cutting blade from a retracted position, to an initiation position where said cutting blade barely engages said craft stick upper surface, to a cutting position where said cutting blade operates to cut said craft stick.

19. An improved cutter for a craft stick, said craft stick having a top surface opposite a bottom surface, said cutter comprising:
a body, said body defining a first opening on a first side and a second opening on a second side, said first and second openings defining a passageway through said body, said passageway for positioning a craft stick to be cut, said passageway having a support surface upon which a craft stick to be cut is placed with its bottom surface facing said support surface, said body comprising a plurality of alignment marks for allowing a user to align a craft stick to be cut along a desired angle, said alignment marks defining a plurality of angles;
a mounting means extending above the support surface and mounting a cutting blade for movement toward and away from the support surface in a cutting plane;
a cutting blade mounted on the mounting means for said movement in the cutting plane, the cutting blade having a cutting edge engagable with the top surface of the craft stick when placed on the support surface; and
a cutting force applying means operatively connected with the mounting means to impart a cutting force thereto to cut said craft stick.

20. The cutter of claim 19, wherein the cutting force applying means comprises a linear actuator operating to move the mounting means and the mounted cutting blade from a retracted position, to an initiation position where said cutting blade barely engages said craft stick upper surface, to a cutting position where said cutting blade operates to cut said craft stick; and wherein a craft stick to be cut can be placed upon the support surface, the cutting force applying means operated to move the mounted cutter blade from its retracted position to the initiation position where said cutting blade barely engages said craft stick upper surface, wherein said user then adjusting the orientation of the craft stick to align the craft stick with at least one of said alignment marks, whereupon said mounted cutter blade is moved into its cutting position where said cutting blade operates to cut said craft stick.
